(19) United States
(12) Patent Application Publication
(10) Pub. No.: US 2009/0238404 A1
(43) Pub. Date: Sep. 24, 2009

(54) METHODS FOR USING DEFORMABLE MODELS FOR TRACKING STRUCTURES IN VOLUMETRIC DATA

(76) Inventors: Fredrik Orderud, Trondheim (NO); Stein Inge Rabben, Sofiemyr (NO); Joger Hansegard, Oslo (NO)

Correspondence Address: DEAN D. SMALL;THE SMALL PATENT LAW GROUP LLP, 225 S. MERAMEC, STE. 725T, ST. LOUIS, MO, 63105, US

(21) Appl. No.: 12/050,715

(22) Filed: Mar. 18, 2008

(51) Int. Cl. G06T 7/20

(52) U.S. Cl. 382/103

(57) ABSTRACT

A computerized method for tracking of a 3D structure in a 3D image including a plurality of sequential image frames, one of which is a current image frame, includes representing the 3D structure being tracked with a parametric model with parameters for local shape deformations. A predicted state vector is created for the parametric model using a kinematic model. The parametric model is deformed using the predicted state vector, and a plurality of actual points for the 3D structure is determined using a current frame of the 3D image, and displacement values and a measurement vectors are determined using differences between the plurality of actual points and the plurality of predicted points. The displacement values and the measurement vectors are filtered to generate an updated state vector and an updated covariance matrix, and an updated parametric model is generated for the current image frame using the updated state vector.

### BACKGROUND OF THE INVENTION

The emergence of volumetric image acquisition within the field of medical imaging has attracted a large amount of scientific interest in recent years. Many different approaches to segmentation and tracking of deformable models in volumetric datasets have been proposed, including both novel algorithms and extensions of existing algorithms to 3D datasets. The presently known past attempts are, however, limited to offline operation due to the extensive processing requirements of the current methods, even though volumetric acquisition may be performed in real-time with the latest generation of 3D ultrasound technology. Presently, no method for real-time tracking or segmentation of such data is available.

The availability of technology for real-time tracking in volumetric datasets would open up possibilities for instant feedback and diagnosis using medical imaging. There is, for instance, a clinical need for real-time monitoring of cardiac function during invasive procedures and intensive care. The automatic tracking of parameters, such as volume, of the main chamber of the heart, the left ventricle (LV), would be one beneficial application of real-time tracking.

In 4D echocardiography, a sequence of volumetric images of a patient's heart is recorded using an ultrasound scanner. Compared to conventional 2D echocardiography, 4D echocardiography increases the complexity of visualization and analysis of the acquired data. Thus, a high degree of manual interaction is required to extract clinically useful information. Typical examples of such manual interaction include cropping of volumetric data for visualization of valve function, alignment of 2D cut-planes within the 3D dataset to obtain standardized clinical cardiac views, and tuning of rendering parameters for optimal visualization of the cardiac wall. Further, manual placement of regions of interest (ROIs) may be required to assess blood flow using Doppler imaging techniques, or strain measurements using speckle-tracking techniques.

Most quantitative evaluations of the heart involve examining the state and function of the left main chamber of the heart. Important quantities that are evaluated include the size of this chamber, the shape of this chamber, and the contraction pattern of this chamber. Cardiac function is commonly assessed manually in 2D echocardiography, but with the introduction of 4D echocardiography, some semi-automated analysis tools have been developed. Nevertheless, known semi-automated analysis tools still require a high degree of manual interaction to initialize visualization and analysis algorithms and to correct the results obtained.

Thus, what is needed are methods and apparatus for automated detection and tracking of the position and shape of a wall of an object in real-time without user-interaction. Such methods and apparatus that meet the above challenges, would improve efficiency and accuracy of, for example, clinical procedures.

### BRIEF DESCRIPTION OF THE INVENTION

In one embodiment of the present invention, a computerized method for tracking of a 3D structure in a 3D image including a plurality of sequential image frames, one of which is a current image frame, is provided. The method includes representing the 3D structure being tracked with a parametric model with parameters for local shape deformations. A predicted state vector is created for the parametric model using a kinematic model. The parametric model is deformed using the predicted state vector, and a plurality of actual points for the 3D structure is determined using a current frame of the 3D image, and displacement values and a measurement vectors are determined using differences between the plurality of actual points and the plurality of predicted points. The displacement values and the measurement vectors are filtered to generate an updated state vector and an updated covariance matrix, and an updated parametric model is generated for the current image frame using the updated state vector.

In yet another embodiment of the present invention, an ultrasound imaging system is provided for tracking a 3D structure in a 3D image including a plurality of sequential image frames, wherein the sequential image frames include a current image frame. The ultrasound imaging system includes an ultrasound transmitter and an ultrasound receiver configured to receive reflected ultrasound radiation reflected from a region of interest of an object and to convert received ultrasound radiation into image data, a processor configured to analyze image data, and a display configured to show results from the analysis of image data. The ultrasound imaging system is further configured to perform the method recited immediately above.

In still another embodiment of the present invention, a machine readable medium or media is provided. The medium or media have recorded thereon instructions configured to instruct a computer or an ultrasound imaging system to represent a 3D structure being tracked with a parametric model with parameters for local shape deformations, create a predicted state vector for the parametric model using a kinematic model, deform the parametric model using the predicted state vector, determine a plurality of actual points for the 3D structure using a current frame of the 3D image, determine displacement values and a measurement vectors using differences between the plurality of actual points and the plurality of predicted points, filter the displacement values and the measurement vectors using a least squares method to generate an updated state vector and an updated covariance matrix, and generate an updated parametric model for the current image frame using the updated state vector.

### BRIEF DESCRIPTION OF THE DRAWINGS

FIG. 1 is an illustration of the Doo-Sabin subdivision process.

FIG. 2 is an example a deformable subdivision model.

FIG. 3 is a block diagram of an exemplary Kalman filter framework suitable for use in embodiments of the present invention.

FIG. 4 is a graphical illustration of normal displacement measurements along normal vectors of points on a predicted contour.

FIG. 5 is a view of a superposition of the initial contour model over an ultrasound image of a left ventricle before deformation.

FIG. 6 is a view similar to FIG. 5 illustrating the superposition of an updated, deformed contour model.

FIG. 7 is an illustration of a method for local shape deformation and global pose transformation.

FIG. 8 is an illustration of an exemplary left ventricle model based on a quadratic B-spline surface.

FIG. 9 is an illustration of an exemplary active shape model. Addition of deformation modes to an average shape creates a new shape.

FIG. 10 is a block diagram of an ultrasound imaging system suitable for implementing method embodiments of the present invention.

FIG. 11 is a flow chart of an exemplary method embodiment of the present invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Scalars are expressed in italic, vectors in boldface and matrices in uppercase boldface. Control vertices are denoted ‘q,’ displacement directions ‘d,’ surface points ‘p,’ and surface normal vectors ‘n.’ State vectors are denoted ‘x.’ Discrete time is denoted with subscript ‘k’ for the Kalman filter, and control vertex or surface point indices are denoted with subscript ‘i’.

Doo-Sabin surfaces [see Doo, D. and Sabin, M., “Behaviour of recursive division surfaces near extraordinary points,” J. Computer-Aided Design, November 1978, No. 6, pp. 356-360] are a type of subdivision surface that generalize bi-quadric B-spline surfaces to arbitrary topology. Following the same approach as Stam for Catmull-Clark surfaces [see Stam, J., “Exact evaluation of Catmull-Clark subdivision surfaces at arbitrary parameter values,” SIGGRAPH '98: Proceedings of the 25th annual conference on computer graphics and interactive techniques, 1998, pp. 395-404, ACM Press, New York, N.Y., ISBN 0-89791-999-8] we define a Doo-Sabin subdivision as a matrix operation. Each surface patch can be subdivided into four new sub-patches by multiplying the N_{q}×3 control vertex matrix Q₀ with the (N_{q}+7)×N_{q} subdivision matrix S. The content of this matrix originates from the regular Doo-Sabin subdivision rules, which are outlined in Appendix A below. Control vertices for the region of support for each sub-patch kε{0,1,2,3} of choice can then be extracted from the subdivided control vertices using a picking matrix Pₖ, such that Q_{n+1,k}=PₖSQₙ.

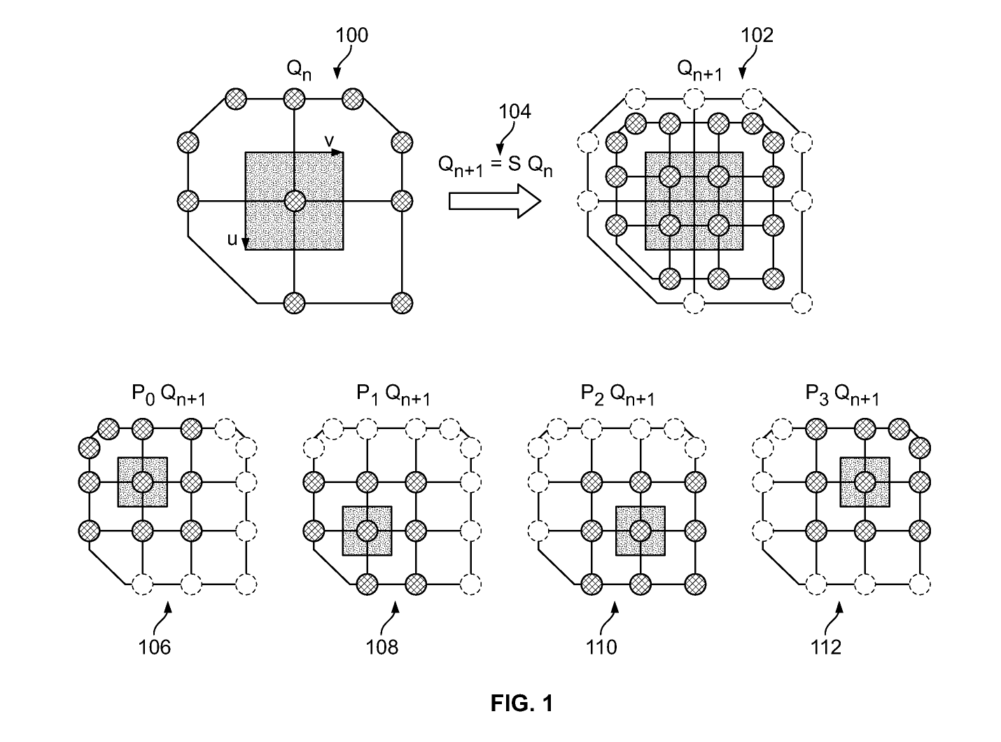

For example, referring to the illustration of the Doo-Sabin subdivision process shown in FIG. 1, control vertices Qₙ that define an initial surface patch 100 are subdivided into new control vertices Qₙ₊₁ 102 by multiplying Qₙ with the subdivision matrix S at 104. Application of the picking matrix Pₖ on Qₙ₊₁ at 106, 108, 110, and 112 further divides the subdivided mesh into four sub-patches that together span the same surface area as the original patch.

Regardless of the topology of Qₙ, all sub-patches Q_{n+1,k} will at most consist of a single irregular face in addition to three regular faces. Successive subdivision operations on Q_{n+1,k} will then yield a single irregular patch, while the three others become regular bi-quadric spline patches that can be evaluated directly.

By assuming, without loss of generality, that the irregular face in Qₙ₊₁ is located top-left, then the picking matrix Pₖ gives a regular 3×3 bi-quadric control vertex mesh when k≠0, and an irregular mesh consisting of N_{q} control vertices when k=0. This relation can be exploited by performing repeated subdivisions n times until the desired surface point is no longer within an extraordinary patch (k≠0). Denoting S₀=P₀S, we can express this as Q_{n,k}=PₖSS₀ⁿ⁻¹Q₀.

The number of subdivision steps n required depends on the logarithm of (u,v), while the sub-patch to pick after the final subdivision is determined using the following criteria:

$$n = ⌊ - {log}_{2} ( max \{ u , v \} ) ⌋$$

$$k = \{ \begin{matrix}1 & if {2}^{n} u > 1 / 2 and {2}^{n} v < 1 / 2 \\ 2 & if {2}^{n} u > 1 / 2 and {2}^{n} v > 1 / 2 \\ 3 & if {2}^{n} u < 1 / 2 and {2}^{n} v > 1 / 2\end{matrix}$$

Direct evaluation of surface points can then be performed for any patch location (u,v) except (0,0), by subdividing a sufficient number of times, until the new subdivided patch below (u,v) no longer contains an extraordinary face, and treating the resulting sub-patch as an ordinary bi-quadric spline surface. For locations near (0,0), an approximate surface evaluation can be obtained by perturbing (u,v) slightly to prevent n from growing beyond a predefined upper limit.

Basis functions with regard to the original non-subdivided control vertices can similarly be determined using a similar approach:

b(u,v)|_{Ω}_{ₖ}_{ⁿ}=(PₖSS₀ⁿ⁻¹)^{T} b̅(t_{k,n}(u,v)),

where Ωₖⁿ is the subdivision mapping function described above that determines the number of subdivision steps required based on (u,v) [see Stam, cited above]. b̅ is the regular bi-quadric B-spline basis functions defined in Appendix B below, and t_{k,n} is a domain mapping function used to map the parametric interval (u,v) to the parametric interval within the desired sub-patch:

$${t}_{k , n} ( u , v ) = \{ \begin{matrix}( {2}^{n + 1} u - 1 , {2}^{n + 1} v ) & if k = 1 \\ ( {2}^{n + 1} u - 1 , {2}^{n + 1} v - 1 ) & if k = 2 \\ ( {2}^{n + 1} u , {2}^{n + 1} v - 1 ) & if k = 3.\end{matrix}$$

Partial derivatives of the basis functions bᵤ and bᵥ are similarly determined by replacing b̅(u,v) with the respective derivatives of the B-spline basis functions in the formula.

Surface positions can then be evaluated as an inner product between the control vertices and the basis functions p (u,v)=Q₀^{T}b(u,v). Note that these embodiments are not dependent on diagonalization of the subdivision matrix, as in Stam. Instead, repeated matrix multiplication performed n times will result in exactly the same result. The associated increase in computational complexity associated with this repeated multiplication will not be a burden if evaluation of basis functions is performed only once, and later re-used to compute surface points regardless of movement of the associated control vertices.

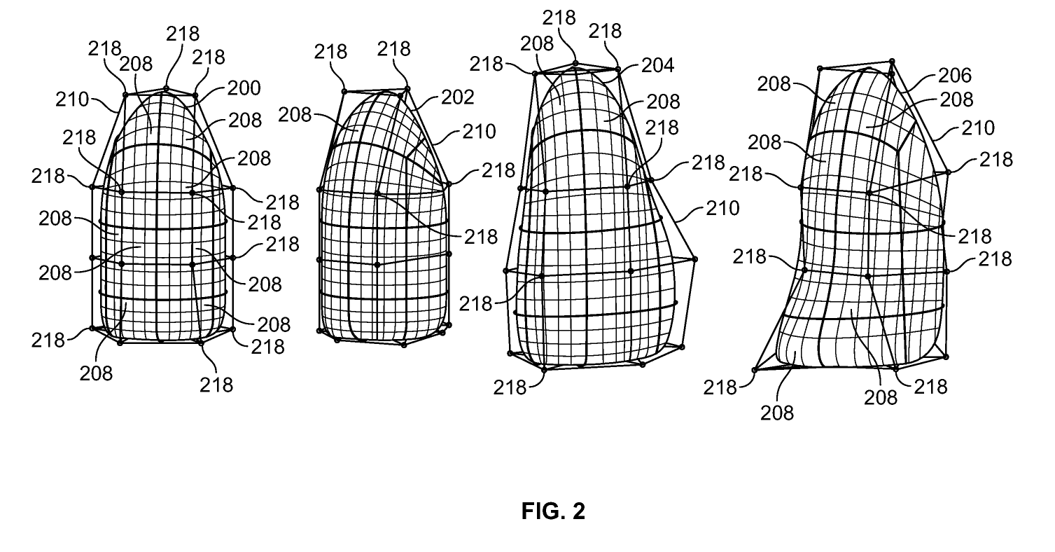

Deformable subdivision models can be incorporated into a Kalman tracking framework. For example, a deformable subdivision model is shown in FIG. 2 by the set of surface renderings of an example undefined subdivision surface for a left ventricle 200, as well as the same model deformed by successive tracking at 202, 204, and 206. This example model consists of 24 surface patches 208 on each model 200, 202, 204, and 206, outlined in FIG. 2 by dark lines. Not all of the surface patches 208 are shown or called out in FIG. 2, but all are tracked successively for each model. The subdivision surface patches 208 are further subdivided into a 5×5 quadrilateral grid solely for visualization purposes. Encapsulating wire-frame meshes 210, 212, 214, and 216 for each model 200, 202, 204, and 206, respectively, illustrate control vertices 218 that define the various surfaces, as well as their topological relationships.

The subdivision models include control vertices qᵢ (218) for iε{1 . . . N_{q}} with associated displacement direction vectors dᵢ that define the direction in which the control vertices are allowed to move. Displacement directions are typically based on surface normals (also known as perpendiculars) because movement of control vertices in this direction results in the greatest change of shape. In addition to the control vertices, the topological relationships between the control vertices are defined in a list C(c). This list maps surface patches cε{1 . . . N_{c}} to enumerated lists of control vertex indices that define the region of support for each surface patch.

The local deformations Tₗ(xₗ) to our deformable model are denoted as the deformations obtainable by moving the control vertices of the subdivision model. These local deformations are combined with a global transform T_{g}(x_{g},pₗ) to position, scale and orient the model within the image volume where the tracking takes place. After creation of the model, a set of surface points are defined for displacement measurements. This set includes parametric coordinates (including patch number) for each of the points (u,v,c)ₗ and are typically distributed evenly across the model surface to ensure robust tracking or segmentation.

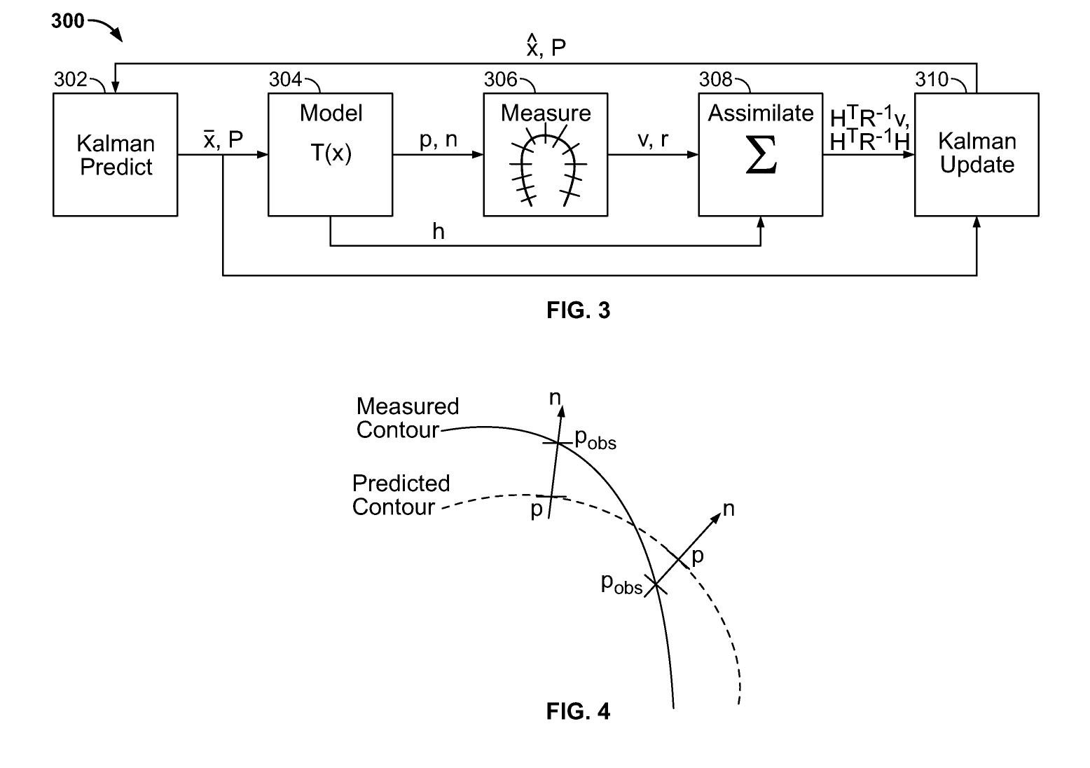

FIG. 3 is a block diagram of an exemplary Kalman filter framework 300 suitable for use in embodiments of the present invention. Kalman filter framework 300 includes the creation of a set of surface points pₗ with associated normal vectors nₗ and Jacobi matrices Jₗ in accordance with a predicted state vector x̅ₗ. The creation of these objects can be performed efficiently by:

1. Updating positions of control vertices qᵢ in accordance with the state vector qᵢ= q̅ᵢ+xᵢdᵢ, where q̅ᵢ is the mean position of the control vertex and xᵢ is a parameter corresponding to this control vertex in the state vector for each control vertex. dᵢ is the displacement direction for control vertex qᵢ. The full state vector for the model then becomes the concatenation of the state parameters for all control vertices xₗ[x₁, x₂, . . . , x_{N}_{ₗ}]^{T}. Some embodiments force certain vertices to remain stationary during tracking without altering the overall approach, thereby reducing the deformation space as well as the number of parameters to estimate.

2. Calculating surface points pₗ as a sums of control vertices weighted with their respective basis functions within the surface patch of each surface point:

$${p}_{l} = {\sum }_{i ∈ C ( {c}_{l} )} {b}_{i} {q}_{i} .$$

3. Calculating surface normals nₗ as the cross product between the partial derivatives of the basis functions with regards to parametric values u and v within the surface patch of each surface point:

$${n}_{l} = {\sum }_{i ∈ C ( {c}_{l} )} {( {b}_{u} )}_{i} {q}_{i} \times {\sum }_{i ∈ C ( {c}_{l } )} {( {b}_{v} )}_{i} {q}_{i} .$$

4. Calculating Jacobian matrices for the local deformations Jₗ by concatenating the displacement vectors multiplied with their respective basis functions: Jₗ=[bᵢ_{₁}dᵢ_{₁}, bᵢ_{₂}dᵢ_{₂}, . . . ]_{iεC(c}_{ᵢ}⁾. The Jacobian matrix will here be padded with zeros for columns corresponding to control vertices outside the region of support for the surface patch of each surface point.

Precomputation of basis functions enables the operations above to be performed very quickly, which aids in the realization of real-time embodiments.

A composite object deformation T(x)=T_{g}(Tₗ(xₗ),x_{g}) of a deformable subdivision model is obtained by combining the local deformations of the subdivision model with a global transform to create a joint model. This combination leads to a composite state vector x=[x_{g}^{T}, xₗ^{T}]^{T} consisting of N_{g} global and Nₗ local deformation parameters. This separation between local and global deformations is intended to ease modeling, because changes in shape are often parameterized differently compared to deformations associated with global position, size and orientation.

In other embodiments of the present invention, incorporation of temporal constraints is accomplished in the prediction module 302 of Kalman filter framework 300 by augmenting the state vector to contain the last two successive state estimates. A motion model that predicts state x̅ at time step k+1, with focus on deviation from a mean state x₀ can then be expressed as:

x̅ₖ₊₁−x₀=A₁(\hat{x}ₖ−x₀)+A₂(\hat{x}ₖ₋₁−x₀),

where \hat{x}ₖ is the estimated state from time step k. Tuning of properties like damping and regularization towards the mean state x₀ for all deformation parameters is then accomplished by adjusting the coefficients in matrices A₁ and A₂. Prediction uncertainty can similarly be adjusted by manipulating the process noise covariance matrix B₀ that is used in the associated covariance update equation for P̅ₖ₊₁. The latter will then restrict the rate of which parameter values are allowed to vary.

Evaluation module 304 evaluates the deformable model. Creation of surface points p, normals n and Jacobian matrices J in accordance with the predicted state x̅ₖ is performed as described above.

An edge measurement module 306 is used to guide the model toward the object being tracked. This is done by measuring the distance between material points on a predicted model inferred from the motion model, and edges found by searching in normal direction of the model surface. This type of edge detection is referred to as normal displacement [see Blake, A. and Isard, A., “Active Contours: The Application of Techniques from Graphics, Vision, Control Theory and Statistics to Visual Tracking of Shapes in Motion,” Secaucus, N.J., Springer-Verlag, New York, Inc., 1998] and is calculated as the normal projection of the distance between a predicted edge point p with associated normal vector n and a measured edge point p_{obs}:

v=n^{T}(p_{obs}−p).

Each normal displacement measurement is coupled with a measurement noise r value that specifies the uncertainty associated with the edge. The value of r is dependent on edge strength and/or other measures of uncertainty. The choice of normal displacement measurements with associated measurements noise enables usage of a wide range of possible edge detectors. The only requirement for the edge detector is that it must identify a promising edge candidate (e.g., the most promising) for each search profile, and assign an uncertainty value to this candidate.

Linearized measurement models [see Bar-Shalom, Y., Li, X. R., and Kirubarajan, T., “Estimation with Applications to Tracking and Navigation,” Wiley-Interscience 2001] that are used in the exemplary Kalman filter framework for each edge measurement are constructed by transforming the state-space Jacobi matrices the same way as the edge measurements, namely by taking the normal vector projection of them:

h^{T}=n^{T}J.

This yields a separate measurement vector h for each normal displacement measurement that relates the normal displacements to changes in the state vector.

A measurement assimilation module 308 is used for state-space segmentation. In some embodiments of the present invention, the number of measurements far exceed the number of state dimensions. Ordinary Kalman gain calculations may thus be computationally intractable, because they can involve inverting matrices with dimensions equal to the number of measurements. Some embodiments of the present invention thus provide an alternative method to assimilate measurements in information space [see Bar-Shalom, Y., Li, X. R., and Kirubarajan, T., “Estimation with Applications to Tracking and Navigation,” Wiley-Interscience 2001] prior to the state update step. This alternative method enables very efficient processing if the measurements are uncorrelated, because since uncorrelated measurements lead to a diagonal measurement covariance matrix R. All measurement information can then be summed into an information vector and matrix of dimensions invariant to the number of measurements:

$${H}^{T} {R}^{- 1} v = {\sum }_{i} {h}_{i} {r}_{i}^{- 1} {v}_{i}$$

$${H}^{T} {R}^{- 1} H = {\sum }_{i} {h}_{i} {r}_{i}^{- 1} {h}_{i}^{T} .$$

A Kalman update module 310 is provided in some embodiments of the present invention that use information space updates. Kalman update module 310 utilizes the fact that the Kalman gain is Kₖ=\hat{P}ₖH^{T}R⁻¹ and reformulate the equations to account for measurements in information space. The updated state estimate \hat{x} for time step k then becomes:

\hat{x}ₖ= x̅ₖ+\hat{P}ₖH^{T}R⁻¹vₖ.

The updated error covariance matrix \hat{P} can similarly be calculated in information space to avoid inverting unnecessary large matrices:

\hat{P}ₖ⁻¹= P̅ₖ⁻¹+H^{T}R⁻¹H.

This form only requires inversion of matrices with dimensions equal to the state dimension.

A wide range of parameterized deformation models can be used in embodiments of the present invention, including splines, active shape, sub-division, speckle-tracking and nonlinear biomechanical models. Although various models can be used, for many of these, it must be possible to compute all partial derivatives of the point position as a function of the deformation parameters. The transformation of contour normals also requires calculation of the spatial derivatives. This method differs from the linear shape space deformations used in prior 2D methods, where all deformations had to be linear in the state vector, and hence did not need any partial derivative calculations.

In some embodiments a global pose transform may be used in addition to local shape deformations of the models. The global pose transformation model that includes the following parameters is defined:

Translation (tₓ,t_{y},t_{z}).

Scaling (s).

Rotation/orientation (rₓ,r_{y}).

This transformation model yields a global state vector x that contains 6 parameters:

x=[tₓt_{y}t_{z}srₓr_{y}]^{T}

Thus, in one embodiment of the present invention, a transformation model is written:

$$[ \begin{matrix}x \\ y \\ z\end{matrix} ] = s [ \begin{matrix}1 & 0 & 0 \\ 0 & cos ( {r}_{x} ) & sin ( {r}_{x} ) \\ 0 & - sin ( {r}_{x} ) & cos ( {r}_{x} )\end{matrix} ] [ \begin{matrix}cos ( {r}_{y} ) & 0 & - sin ( {r}_{y} ) \\ 0 & 1 & 0 \\ - sin ( {r}_{y} ) & 0 & cos ( {r}_{y} )\end{matrix} ] [ \begin{matrix}{x}_{0} \\ {y}_{0} \\ {z}_{0}\end{matrix} ] + [ \begin{matrix}{t}_{x} \\ {t}_{y} \\ {t}_{z}\end{matrix} ]$$

Kinematic models are used in some embodiments of the present invention to predict states between successive image frames. These models use prior knowledge to yield both a prediction for the state vector and a covariance that which specifies prediction uncertainty. The prediction is used as a starting point for more accurate refinements, called updates, in which the prediction is combined with measurements from the current frame to form more accurate estimates.

Most types of video tracking, including contour tracking, deal with moving, deformable objects that are non-stationary both in shape, alignment and position, thereby adding complexity to the state prediction. Simple state estimates from the previous frame do not suffice as inputs for a kinematic model because contour state vectors do not incorporate notions of motion or rate of change. A method for capturing temporal development in addition to spatial changes is therefore provided in some embodiments of the present invention. The use of kinematic properties, such as motion damping, shape and pose regularization for the object being tracked, as well as an allowed rate of change for deformation parameters can help guide tracking by restricting the search space. In addition, outlier displacement measurements can be discarded and temporal coherence for the contour can be imposed.

The state prediction stage of a Kalman filter provides a framework for such modeling. Modeling of motion in addition to position in some embodiments of the present invention by augmenting the state vector to contain the last two successive state estimates from the previous two image frames and forming a second order autoregressive model. A kinematic model which predicts state x at timestep k+1, with focus on deviation from a mean state x0, is written:

x̅ₖ₊₁−x₀=A₁(\hat{x}ₖ−x₀)+A₂( x̅ₖ₋₁−x₀),

where \hat{x}ₖ is the estimated state from timestep k. Tuning of properties like damping and regularization towards the mean state x₀ for all deformation parameters is then accomplished by adjusting the coefficients in matrices A₁ and A₂. Prediction uncertainty is similarly adjusted by manipulating the process noise covariance matrix B₀ used in the associated covariance update equation. The latter adjustment restricts the rate of which parameter values are allowed to vary.

Alternative kinematic models, including models of higher order and nonlinear models, can also be used without alteration of the overall framework.

After a predicted state vector x is determined for the model based upon past image frames, the transformation model is used in conjunction with the predicted state vector to create contour points p with associated normal vectors n, based on the predicted state vector, as described above.

In some embodiments of the present invention, state-space Jacobi matrices are evaluated at the predicted state vector to relate changes in the point positions to changes in the state to allow processing of displacement measurements using an extended Kalman filter. Separate Jacobian matrices for each point are also calculated. These matrices comprise partial derivatives of points with regard to all transformation parameters:

$$\frac{\partial {T}_{0} ( {p}_{0} , x )}{\partial x} = [ \begin{matrix}\frac{\partial {p}_{x}}{\partial {x}_{1}} & \frac{\partial {p}_{x}}{\partial {x}_{1}} & … & \frac{\partial {p}_{x}}{\partial {x}_{N}} \\ \frac{\partial {p}_{y}}{\partial {x}_{1}} & \frac{\partial {p}_{y}}{\partial {x}_{2}} & … & \frac{\partial {p}_{y}}{\partial {x}_{N}} \\ \frac{\partial {p}_{z}}{\partial {x}_{1}} & \frac{\partial {p}_{z}}{\partial {x}_{2}} & … & \frac{\partial {p}_{z}}{\partial {x}_{N}}\end{matrix} ] .$$

After the deformation has been created, feature detection is used to detect the presence and position of features in the image A feature is usually defined to be any significant change in image intensity occurring over a short spatial scale. For example, edge detection is used to determine points along the inner wall of the left ventricle.

Spatial derivative-filtering can be used to enhance changes in image intensity, with subsequent thresholding then revealing the position of any features present. However, spatial derivative filtering also enhances noise, so it is not necessarily a preferred method for edge detection in embodiments of the present invention. Furthermore, although entire images can be processed at once, the processing of entire images can be computationally demanding. On the other hand, the use of tracking in some embodiments of the present invention provides a processing improvement, because only normals need be examined, allowing for simpler feature detection in which only a few pixels need be examined for each point.

It is contemplated that either step edge detection or peak edge detection models may be utilized in embodiments of the present invention. Additionally, other displacement measurement methods may be utilized in embodiments of the present invention. For example, techniques for following material motion between successive frames, such as block-matching, optical flow estimation and non-rigid registration techniques are utilized in some embodiments of the present invention.

A displacement measurement is obtained by a method that includes measuring the distance between material points inferred from the kinematic model and actual image features found in the neighborhood of the surface. The type of displacement measurements performed in the normal direction of the surface is referred to as normal displacement. However, some embodiments of the present invention perform displacement measurements using at least one method that includes searching in directions other than the normal direction, such as block-matching and/or optical flow estimation methods.

The normal displacement between a predicted point p with associated normal vector n and a measured feature point p_{obs} is defined as normal projection of the distance between the material points, as shown in FIG. 4:

$$v = [ \begin{matrix}{n}_{x} & {n}_{y} & {n}_{z}\end{matrix} ] ( [ \begin{matrix}{p}_{obs , x} \\ {p}_{obs , y} \\ {p}_{obs , z}\end{matrix} ] - [ \begin{matrix}{p}_{x} \\ {p}_{y} \\ {p}_{z}\end{matrix} ] ) ,$$

which in vector form is written:

v=n^{T}(p_{obs,x}−p).

Each displacement measurement is coupled with a measurement noise r value that specifies the uncertainty associated with the feature. This uncertainty may be constant for all features or dependent on feature strength or other measure of uncertainty.

This choice of displacement measurements with associated measurements noise enables the use of a wide variety of displacement measurement methods that identify a most promising feature-candidate in the neighborhood of the predicted point, and that assign an uncertainty value to this candidate.

Linearized measurement models, which are used in the Kalman filter for each displacement measurement, are constructed by transforming the state-space Jacobi matrices in the same manner as the normal displacement measurements, namely taking the normal vector projection of them:

$${h}^{T} ≡ {n}^{T} \frac{\partial T ( {p}_{0} , x )}{\partial x} .$$

A separate measurement vector h is obtained for each displacement measurement that relates the displacements to changes in contour state.

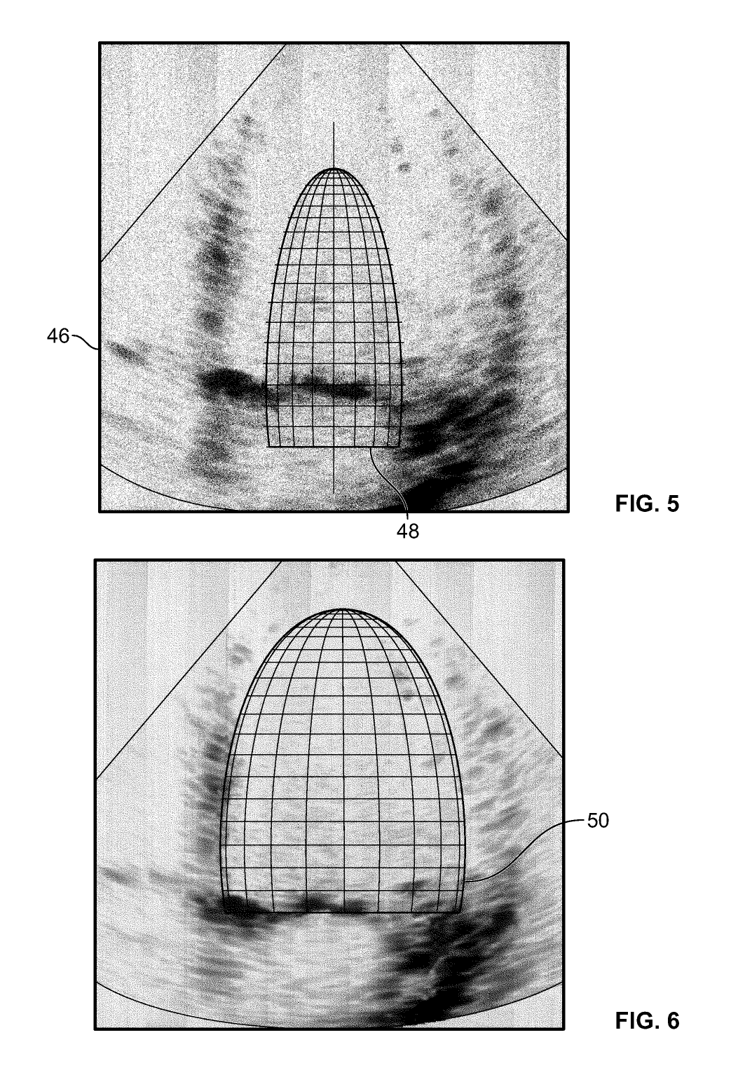

FIG. 5 shows an example carried out using an exemplary method of the present invention. An ultrasound image 46 is shown that includes a view of a left ventricle. In one embodiment of the present invention, an initial model 48 is displayed on a display screen superimposed over the ultrasound image 46. The dimensions of model 48 in this example do not match the cardiac chamber shown in the ultrasound image.

In accordance with one of the embodiments described above, model 48 is updated utilizing information from the previous ultrasound image frames and the updating steps described, including the feature detection methods. Following the updating steps, an updated model 50 is developed that more closely matches the size and shape of the cardiac chamber being analyzed.

After the updated model 50 has been developed, the volume of the updated contour model can be easily determined using any suitable conventional technique. The calculated volumes can then be displayed on a display screen in real-time as a user monitors the ultrasound image as shown in FIG. 6.

In yet other embodiments of the present invention, a tracking framework is based upon a deformation modelT, which is decomposed into local deformations and global transformations. Local shape deformations are used to alter contour shape, by deforming points on a shape template p₀ into intermediate contour shape points pₗ, using a local shape deformation model Tₗ with local state vector xₗ as parameters:

pₗ=Tₗ(p₀,xₗ).

The intermediate shape points pₗ are subsequently transformed into final points p using a global pose transformation model T_{g} with global state vector x_{g} as parameters:

p=T_{g}(pₗ,x_{g}).

A composite deformation model T is then constructed by combining local and global deformations of shape template points into a joint model to obtain a composite state vector x=[x_{g}^{T},xₗ^{T}]^{T} that comprises N_{g} global and Nₗ local deformation parameters. Calculation and propagation of associated normals n through T is also performed to specify a local search region for a later displacement measurement.

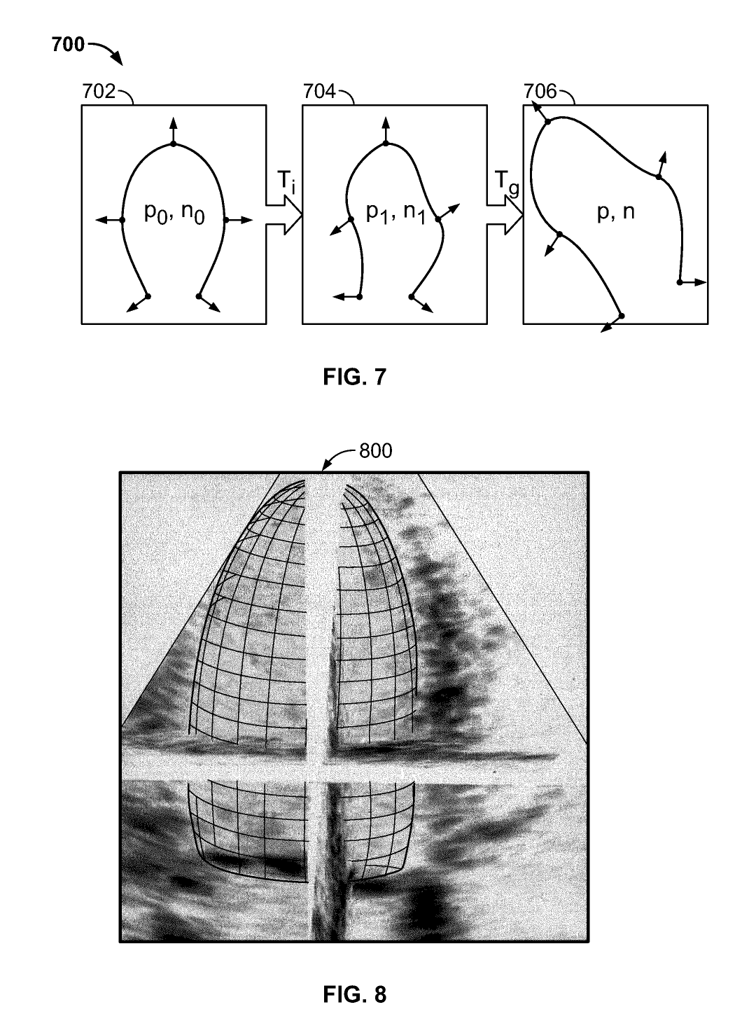

More particularly, FIG. 7 is an overview of a deformation and transformation process 700. A shape template p₀,n₀ (702) is first deformed locally into pₗ,nₗ (704). Next, a global transformation transforms pₗ,nₗ into a final contour p,n (706).

This separation between local and global deformations eases modeling, because changes in shape are often parameterized differently than transformations associated with global position, size, and orientation. The separation between local and global deformations also places very few restrictions on the allowable deformations, so a wide range of parameterized deformation models can be used, including nonlinear models, as opposed to prior art shape space models that are limited to linear deformations.

A deformable surface is used in some embodiments of the present invention to represent shapes of cardiac structures, such as the left ventricle of a heart. This surface representation can utilize one or more parametric surface models that are controlled by a finite set of shape parameters. These parametric surface models can encompass, for example, polygonal meshes, spline surfaces, active-shape models, subdivision surfaces and other models.

Deformable models are based on a polynomial function interpolation of control points q_{i,j} that are allowed to move to alter a surface shape. Such models include but are not limited to spline surfaces.

Spline models are described by spatial positions of their control points. The control points q_{i,j} are allowed to move relative to one another to alter the surface shape. For example, control points q_{i,j} are allowed to move freely in the x, y, and z directions in some embodiments, or in some other embodiments by restricting movement of control points q_{i,j} to a single direction that may, but need not be, constrained to be perpendicular to the surface.

A state vector for a spline surface shape can be constructed by concatenating coordinates of all control points:

xₗ=[{q_{1,1}}ₓ,{q_{1,1}}_{y},{q_{1,1}}_{z},{q_{1,2}}ₓ,{q_{1,2}}_{y},{q_{1,2}}_{z}, . . . , {q_{M,N}}_{z}]^{T}

In embodiments that restrict deformation of control points of spline surfaces, the state vector can instead be constructed by concatenating displacement values for each control point along a predefined movement direction.

xₗ=[d_{1,1},d_{1,2}, . . . , d_{M,N}]^{T}

The latter state representation reduces the dimensionality of the state vector by a factor of three at the small cost of some additional storage for mean control point position q̅_{i,j} and displacement direction n̅_{i,j}, which typically remains fixed during tracking.

In one exemplary embodiment of the present invention, a deformable spline model for the left ventricle is constructed by distributing control points on each side of the cavity in a prolate spheroid grid. The control points are then allowed to move in a direction perpendicular to the surface to produce shape deformations.

The local shape deformations are combined with a global transformation model comprising modes for translation and scaling in three dimensions, as well as modes for rotation. FIG. 8 is an illustration of one exemplary left ventricle model 800 based on a quadratic B-spline surface.

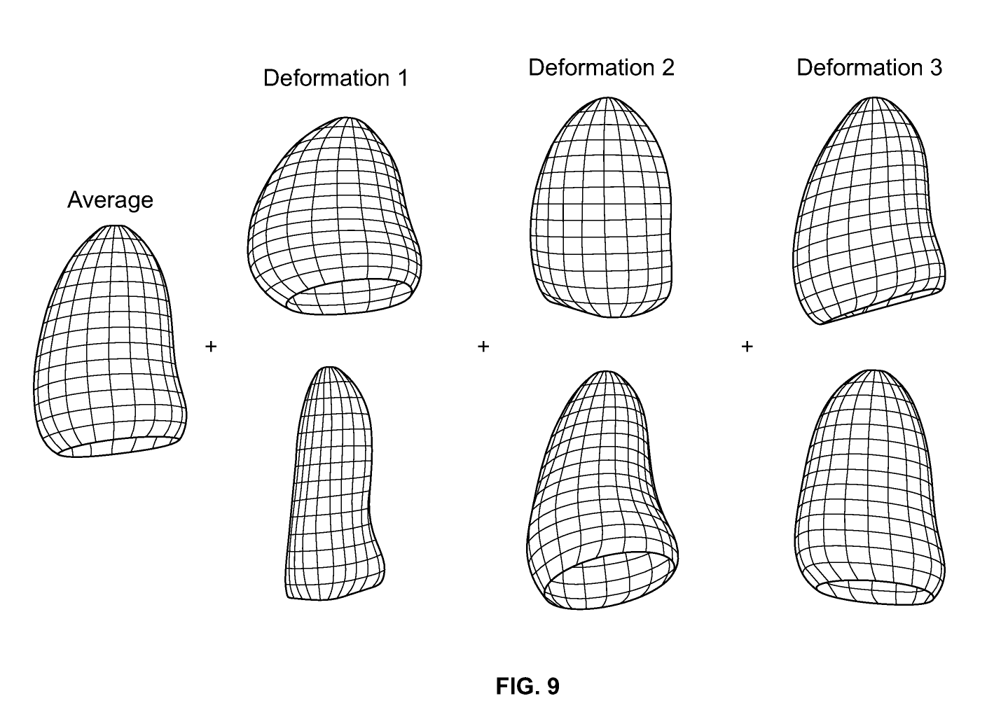

Some embodiments of the present invention utilize an active shape model (ASM) that is described by a number of shape parameters. A three-dimensional active shape model (3D ASM) comprises an average 3D shape and a number of deformation modes. A new shape is created by adding various amount of each deformation mode to the average shape as shown in FIG. 9. The shape parameters control the contribution of each deformation. This model can be formulated as

qᵢ(xₗ)= q̅ᵢ+Aᵢxᵢ,

where q̅ᵢ represents the mesh nodes of the average shape, the deformation modes are included in the matrix Aᵢ, and xₗ is a vector of shape parameters, controlling the amount of each deformation. If there are Nₓ different deformation modes, then Aᵢ is a 3×Nₓ matrix, and the matrix-vector multiplication becomes a computational bottleneck. To overcome this problem, the equation for the ASM is rewritten, assuming that each deformation mode is directed along the surface normals n̅ᵢ of the average shape. The equation for the ASM can then be rewritten as

qᵢ(xₗ)= q̅ᵢ+ n̅ᵢ(Aᵢ^{⊥}xₗ),

where Aᵢ^{⊥} is an Nₓ-dimensional vector, reducing the number of multiplications and summations by a factor of three.

In some embodiments of the present invention, the ASM is constructed from a set of training shapes representing different variations of the target object. These training shapes can be obtained by manual annotation or by using a semi-automated segmentation tool. For 4D echocardiography, the shapes are extracted from a population of patients. Ideally, the shapes include a wide variety of cardiac shapes.

The training shapes from all patients are resampled to a common topological structure, e.g. quadrilateral meshes, and aligned in space to remove trivial pose variations such as position, rotation and scaling. Using a technique known as principal component analysis (PCA), the average shape and the different deformation modes (e.g. the eigenvectors) are extracted directly from the aligned meshes.

Using quadrilateral mesh structure, the discrete mesh can be interpolated to a continuous surface using spline interpolation. An arbitrary point on the ASM in normalized coordinates can be expressed as pₗ(x)ₗ=Tₗ|_{(u,v)} where (u,v) represents the parametric position on the surface, and the local transformation Tₗ includes the deformation and interpolation applied to the average mesh. The number of shape parameters required is a trade-off between accuracy and computational load, but in some embodiments of the present invention, 10 to 20 modes are sufficient.

An extension is provided in some embodiments of the present invention to enable usage of 3D spline surfaces and ASMs in a Kalman filter for real-time tracking or segmentation. This extension is provided by using the shape parameters xₗ directly, in addition to the global pose parameters x_{g}, in the Kalman filter state vector.

Processing of displacement measurements using an extended Kalman filter requires state-space Jacobi matrices to relate changes in point positions to changes in state. [See Yaakov Bar-Shalom, X. Rong Li, and Thiagalingam Kirubarajan, Estimation with Applications to Tracking and Navigation, Wiley-Interscience, 2001.] Separate Jacobi matrices for each point are therefore calculated in some embodiments of the present invention. The choice of composite deformations leads to state-space Jacobi matrices consisting of two separate parts, namely of global and local derivatives:

$$\frac{\partial {T ( {p}_{0} , x )}_{i}}{\partial x} ≡ [ \frac{\partial {T ( {p}_{l} , {x}_{g} )}_{i}}{\partial {x}_{g}} , {\sum }_{n ∈ x , y , z} \frac{\partial {{T}_{g} ( {p}_{l} , {x}_{g} )}_{i}}{\partial {p}_{l , n}} \frac{\partial {{T}_{g} ( {p}_{0} , {x}_{l} )}_{n}}{\partial {x}_{l}} ] .$$

The global Jacobian becomes a 3×N_{g} matrix, while the Jacobian for the local shape deformations becomes the product of a 3×3 matrix by a 3×Nₗ matrix using the chain rule for multivariate calculus.

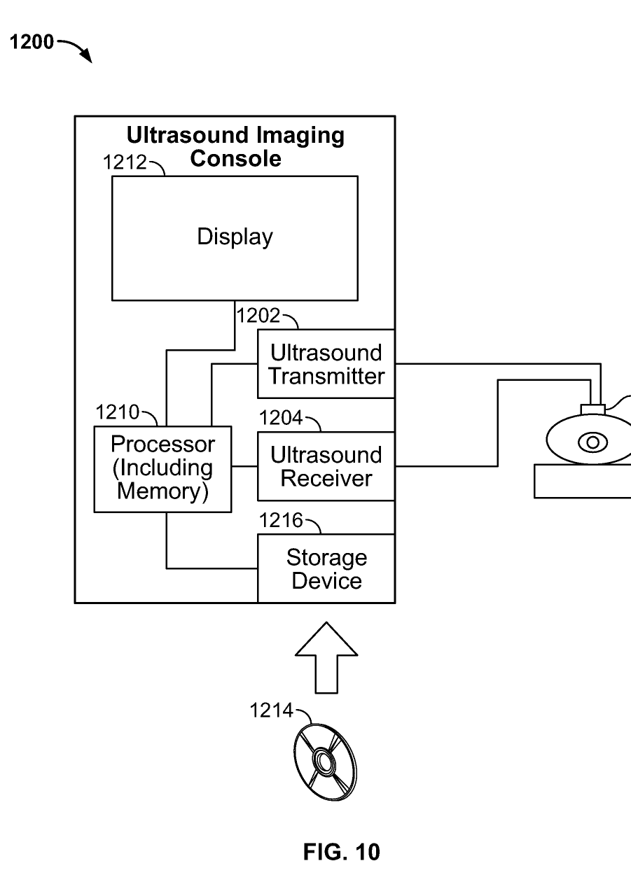

A block diagram of an ultrasound imaging system 1200 suitable for implementing method embodiments of the present invention is shown in FIG. 10. Ultrasound imaging system 1200 includes an ultrasound transmitter 1202 and an ultrasound receiver 1204 configured to receive reflected ultrasound radiation reflected from a region of interest of an object 1206 and to convert received ultrasound radiation into image data. Object 1206 may be, for example, a medical patient, and the region of interest may, for example, include the heart of the patient. To emit ultrasound radiation into object 1206 and to receive reflected ultrasound radiation therefrom, an ultrasound probe 1207 is used to obtain successive frames of image data. Ultrasound imaging system 1200 also includes a processor 1210 configured to analyze the image data, and a display 1212 configured to show results from the analysis of the image data. Processor 1210 can be a module comprising a computational/logic engine (e.g., a microprocessor or CPU) together with memory, not shown separately in FIG. 10.

In some embodiments of the present invention, a storage device 1216 is configured to read instructions from an external medium or media 1214 such as CD-ROM, DVD, floppy disks, or other types of machine readable media known in the art. Instructions on medium or media 1214 are configured to instruct ultrasound imaging system 1200, for example, via processor 1210, to perform a method embodiment of the present invention.

The methods of the present invention need not necessarily be implemented using an ultrasound imaging system. A subset of the system shown in FIG. 10 is adequate for some embodiments. For example, a computer comprising a processor, memory, and display is suitable for implementing many method embodiments of the present invention, as long as the computer provides a suitable method for transferring image data in real time from an imaging system, such as ultrasound imaging system 1200 of FIG. 10. Furthermore, the imaging system need not be an ultrasound imaging system or a medical imaging system, provided a sequence of image frames can be provided. In cases in which the method embodiments of the present invention are implemented in an ultrasound imaging system 1200, the scope of the present invention does not restrict the physical size of the imaging system. For example, ultrasound imaging system 1200 may be provided in a console format, a portable format, or a hand-held format.

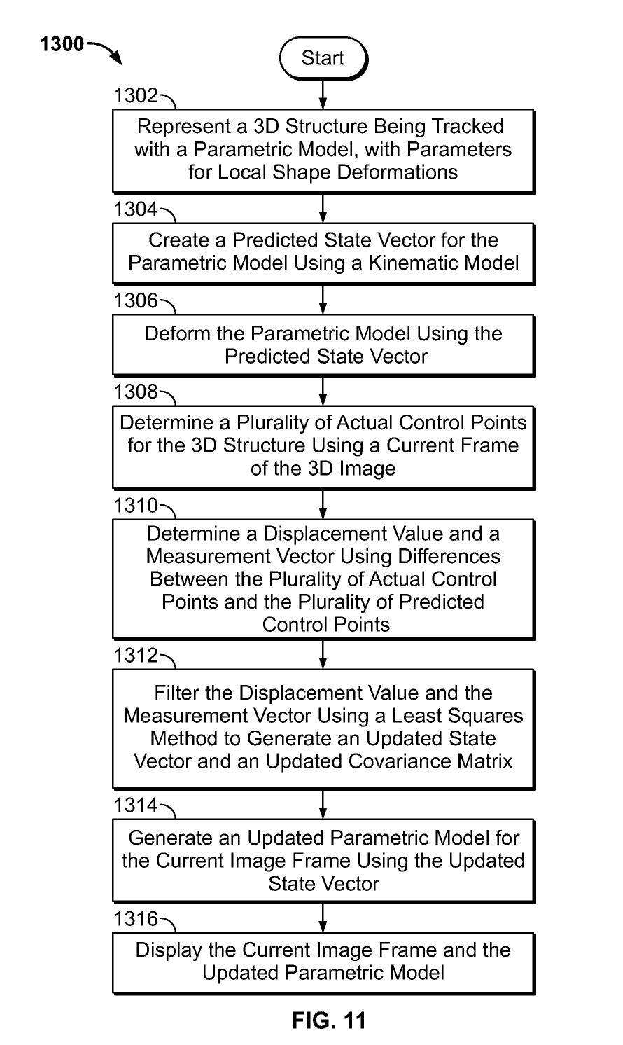

An exemplary method embodiment of the present invention is represented by flow chart 1300 of FIG. 11. Flow chart 1300 is a flow chart of a computer-implemented method for real-time tracking of a 3D structure 1206 in a 3D image including a plurality of sequential image frames. The method includes, at 1302, representing the 3D structure being tracked with a parametric model, with parameters for local shape deformations. At 1304, the method continues by creating a predicted state vector for the parametric model using a kinematic model. Next, at 1306, the method includes deforming the parametric model using the predicted state vector. At 1308, the method next includes determining a plurality of actual points for the 3D structure using a current frame of the 3D image. Following 1308, the method includes, at 1310, determining a displacement value and a measurement vector using differences between the plurality of actual points and the plurality of predicted points. At 1312, the method continues by filtering the displacement value and the measurement vectors using a least squares method to generate an updated state vector and an updated covariance matrix. The method next includes, at 1314, generating an updated model for the current image frame using the updated state vector. At 1316, in some embodiments, the method can include displaying the current image frame and the updated model.

In some embodiments of the present invention, the sequential image frames are obtained using a 3D ultrasound imaging apparatus. Also, in some embodiments, the 3D structure is a cavity of a heart, such as the left ventricle. In some embodiments, the parametric model used is a spline surface having a grid of control points. In some embodiments using a spline surface having a grid of control points, deformations to the spline model are restricted to moving the control points in a direction perpendicular to the spline surfaces to produce shape deformations. (The term “perpendicular,” as used herein and in the claims, and unless otherwise qualified, is meant to include within its scope both perfectly perpendicular and essentially perpendicular, the latter being sufficiently close to perfectly perpendicular that nearly the same effects and benefits that an exact perpendicular would achieve.) Also, in some embodiments using a spline surface having a grid of control points, the parametric model used is a quadratic B-spline surface.

Some embodiments of the present invention utilize a 3D ASM model comprising an average 3D shape and a plurality of deformation modes controlled by a plurality of surface points. In some of these embodiments, deformation of the ASM is restricted to moving the surface points in a direction perpendicular to the average 3D shape to produce shape deformations.

Also in some embodiments, the parametric model used is a subdivision surface having a set of control points. In some of these embodiments, deformation of the subdivision surface is restricted to moving the control points in a direction perpendicular to the surface to produce shape deformations. Also, in some of these embodiments, the subdivision surface is a Doo-Sabin subdivision surface.

Also, in some embodiments of the present invention, a state vector is used that has parameters for both local shape deformations the parametric model and parameters for global positioning, scaling and orientation of the parametric model. In some of these embodiments, Jacobi matrices for the state vector consist of global derivatives and local derivatives.

In yet other embodiments of the present invention, determining the locations of the features includes measuring a distance between material points on a predicted parametric model inferred from a motion model, and searching for features in a perpendicular direction of the contour model surface. In some embodiments, the filtering of displacement values is performed in information space. And in some embodiments, using a least squares model comprises using an extended Kalman filter.

It will thus be appreciated that technical effects of the present invention include the detection and tracking of the position and shape of a wall of an object in real-time without user-interaction. Such methods and apparatus can thereby improve efficiency and accuracy of, for example, clinical procedures.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

### APPENDIX A

### Doo-Sabin Subdivision Matrix

The subdivision weights used for faces consisting of n vertices are used as defined by Doo & Sabin,

$${α}_{n}^{j} = \frac{{δ}_{j , 0}}{4} + \frac{3 + 2 cos ( 2 π j / n )}{4 n} ,$$

where δ_{i,j} is the Kronecker delta function which is one for i=j and zero elsewhere. Subdivision of the control vertices within a single face can then be expressed as a linear operation using a subdivision matrix Sₙ:

$${S}_{n} = [ \begin{matrix}{α}_{n}^{0} & {α}_{n}^{1} & {α}_{n}^{2} & … & {α}_{n}^{- 1} \\ {α}_{n}^{- 1} & {α}_{n}^{0} & {α}_{n}^{1} & … & {α}_{n}^{- 2} \\ {α}_{n}^{- 2} & {α}_{n}^{- 1} & {α}_{n}^{0} & … & {α}_{n}^{- 3} \\ … & … & … & … & … \\ {α}_{n}^{1} & {α}_{n}^{2} & {α}_{n}^{3} & … & {α}_{n}^{0}\end{matrix} ] .$$

Subdivision of whole patches is accomplished by combining Sₙ for all four faces in a patch into a composite subdivision matrix S. The structure of this matrix depends on the topology and control vertex enumeration scheme employed, but construction should be straightforward.

### APPENDIX B

### Basis Functions for Quadratic B-Splines

The nine tensor product quadratic B-spline functions can be expressed as a product of two separable basis polynomials for the parametric value u and v, i=0, . . . , 8:

b̅ᵢ(u,v)=P_{i%3}(u)P_{i/3}(v),

where “%” and “/” denote the division remainder and division operators respectively. Pᵢ(t) are the basis polynomials for quadratic B-splines with uniform knot vectors:

2P₀(t)=1−2t+t²

2P₁(t)=1+2t−2t²

2P₂(t)=t²

What is claimed is:

1. A computer-implemented method for tracking of a 3D structure in a 3D image including a plurality of sequential image frames, wherein the sequential image frames include a current image frame, said method comprising:
representing the 3D structure being tracked with a parametric model with parameters for local shape deformations;
creating a predicted state vector for the parametric model using a kinematic model;
deforming the parametric model using the predicted state vector;
determining a plurality of actual points for the 3D structure using a current frame of the 3D image;
determining displacement values and a measurement vectors using differences between the plurality of actual points and the plurality of predicted points;
filtering the displacement values and the measurement vectors using a least squares method to generate an updated state vector and an updated covariance matrix; and
generating an updated parametric model for the current image frame using the updated state vector.

2. The method of claim 1 further comprising obtaining the plurality of sequential image frames using a 3D ultrasound imaging apparatus.

3. The method of claim 1 wherein the 3D structure is a left ventricle of a heart.

4. The method of claim 1 wherein the parametric model used is a spline surface having a grid of control points.

5. The method of claim 4 further comprising restricting deformation of the spline model to moving the control points in a direction perpendicular to the spline surfaces to produce shape deformations.

6. The method of claim 1 wherein the parametric model used is a three-dimensional active shape model (3D ASM) comprising an average 3D shape having a plurality of surfaces having surface points, and a plurality of deformation modes controlling a plurality of surface points.

7. The method of claim 6 further comprising restricting deformation of the active-shape model to moving the surface points in a direction perpendicular to surfaces of the average 3D shape to produce shape deformations.

8. The method of claim 1 wherein the parametric model used is a subdivision surface having a set of control points.

9. The method of claim 8 further comprising restricting deformation of the subdivision surface to moving the control points in a direction perpendicular to the subdivision surface to produce shape deformations.

10. The method of claim 8 wherein the subdivision surface is a Doo-Sabin subdivision surface.

11. The method of claim 1 further comprising a state vector having parameters for both local shape deformations to the parametric model and parameters for global positioning, scaling and orientation of the parametric model.

12. The method of claim 11 wherein Jacobi matrices for the state vector consist of global derivatives and local derivatives.

13. The method of claim 1 wherein said determining displacement values and measurement vectors further comprises measuring distances between points on a predicted model inferred from a motion model, and searching for features in a perpendicular direction of the parametric model surface.

14. The method of claim 1 wherein said determining displacement values and measurement vectors further comprises measuring distances between material points on a predicted model inferred from a motion model, and searching for the same material points in a local search region around the parametric model surface.

15. The method of claim 1 wherein filtering the displacement values is performed in information space.

16. The method of claim 1 wherein using a least squared method comprises using an extended Kalman filter.

17. An ultrasound imaging system for tracking a 3D structure in a 3D image including a plurality of sequential image frames, wherein the sequential image frames include a current image frames,
said ultrasound imaging system comprising an ultrasound transmitter and an ultrasound receiver configured to receive reflected ultrasound radiation reflected from a region of interest of an object and to convert received ultrasound radiation into image data, a processor configured to analyze image data, and a display configured to show results from the analysis of image data,
said ultrasound imaging system configured to:
represent the 3D structure being tracked with a parametric model with parameters for local shape deformations;
create a predicted state vector for the parametric model using a kinematic model;
deform the parametric model using the predicted state vector;
determine a plurality of actual points for the 3D structure using a current frame of the 3D image;
determine displacement values and a measurement vectors using differences between the plurality of actual points and the plurality of predicted points;
filter the displacement values and the measurement vectors using a least squares method to generate an updated state vector and an updated covariance matrix; and
generate an updated parametric model for the current image frame using the updated state vector.

18. The ultrasound imaging system of claim 17 wherein the parametric model used is a subdivision surface having a mesh of control points.

19. The ultrasound imaging system of claim 17 wherein the parametric model is a Doo-Sabin subdivision surface.

20. A machine readable medium or media having recorded thereon instructions configured to instruct a computer or an ultrasound imaging system to:
represent a 3D structure being tracked with a parametric model with parameters for local shape deformations;
create a predicted state vector for the parametric model using a kinematic model;
deform the parametric model using the predicted state vector;
determine a plurality of actual points for the 3D structure using a current frame of the 3D image;
determine displacement values and a measurement vectors using differences between the plurality of actual points and the plurality of predicted points;
filter the displacement values and the measurement vectors using a least squares method to generate an updated state vector and an updated covariance matrix; and
generate an updated parametric model for the current image frame using the updated state vector.
